(19) United States
(12) Patent Application Publication
(10) Pub. No.: US 2023/0013115 A1
(43) Pub. Date: Jan. 19, 2023

(54) DIGITAL CURRENCY AND A SYSTEM AND METHOD FOR TRANSFERRING VALUE USING THE DIGITAL CURRENCY

(71) Applicant: IMEX USA, Inc., New York, NY (US)

(72) Inventor: Steven Rosamilia, Cedar Grove, NJ (US)

(21) Appl. No.: 17/956,433

(22) Filed: Sep. 29, 2022

Related U.S. Application Data
(63) Continuation-in-part of application No. 17/025,646, filed on Sep. 18, 2020, now abandoned.
Application No. 17/025,646 is a continuation-in-part of application No. 15/750,681, filed on Feb. 6, 2018, now abandoned.
(60) Provisional application No. 62/204,083, filed on Aug. 12, 2015.

(51) Int. Cl. G06Q 20/10; G06Q 20/06; G06Q 20/40; G06Q 20/38

(52) U.S. Cl. CPC G06Q 20/108; G06Q 20/0655; G06Q 20/4014; G06Q 20/389; G06Q 20/381

(57) ABSTRACT

A digital currency whose value is tied to a fiat currency or other thing of value is created in a participant's member account by the participant depositing a fiat currency or other thing of value in a common trust account maintained by a financial institution, and in which a plurality of participants make such deposits. A central authority maintains member accounts for the participants and credits to a participant's member account an international monetary unit (“IMU”) which reflects the value of each deposit that participant makes into the common deposit account. The value of a participants IMU or IMUs is thus determined by the amount which the participant deposits in the trust account. The IMUs may be transferred between participants and the transferred IMU may be denominated in selected sovereign currencies. Alternatively, a transferee participant may redeem an IMU for value, e.g., for a fiat currency, in which case the IMU is retired.

### CROSS-REFERENCE TO RELATED APPLICATIONS

This application is a continuation-in-part application of U.S. patent application Ser. No. 17/025,646, filed Sep. 18, 2020, which is a continuation-in-part application of U.S. patent application Ser. No. 15/750,681, filed Feb. 6, 2018, which is a U.S. national stage application of International Application No. PCT/US2016/046769, which has an international filing date of 12 Aug. 2016, and which claims the benefit of priority of provisional patent application Ser. No. 62/204,083, filed on Aug. 12, 2015, all entitled “DIGITAL CURRENCY AND A SYSTEM AND METHOD FOR TRANSFERRING VALUE USING THE DIGITAL CURRENCY”.

### BACKGROUND OF THE INVENTION

### Field of the Invention

The present invention concerns a novel digital currency and a novel system and method for transferring value domestically or internationally by means of the digital currency. For example, remittances, payments and transfers of funds or other things of value may be made domestically or internationally using the novel digital currency.

### Description of Related Art

With the exception of the physical transfer from one party to another of value, such as tangible goods, gold or fiat currency, traditional methods of transferring value involve antiquated systems that are inefficient and expensive.

The current systems of transferring value actually transport the underlying asset. For example, if Smith is in New York and wants to send £500 to his friend Jones in London, the currency has to be physically moved from one bank to another, sometimes involving several banks. If Smith deposits in his or her bank a currency other than pounds sterling (£), the currency, for example, US dollars ($), must first be converted to pounds sterling. Transfer fees and disadvantageous exchange rates add to the cost of effectuating the transfer of value.

One small segment of the global payments market—migrant workers and expatriates—transferred over US $500 billion in 2014. At an average transfer cost of 8%, according to the World Bank, this market generates over US $40 billion in fees. This figure does not include inflated foreign exchange conversion rates which often bring the actual costs to well over 20%. The total global payments market generated U.S $1.2 trillion in fees in calendar year 2014.

Known digital currencies are sometimes referred to as an “alternate currency” or “cryptocurrency”. Generally, a digital currency is an electronic medium of exchange that is not controlled or issued by any government central bank and therefore, has no intrinsic value. The primary benefit of a digital currency is that it can be electronically transferred from one person or entity to another almost instantaneously. Beyond the benefit of instant transfer, all of the more than six hundred digital currencies in circulation—Bitcoin being the largest—have no intrinsic value whatsoever, other than what two parties agree the value to be. A secondary benefit is that parties exchanging the digital currency can remain anonymous; although this feature has been criticized by government regulators as aiding in criminal activity.

### SUMMARY OF THE INVENTION

Generally, in accordance with the present invention there is provided a novel digital currency which, unlike prior art digital currencies, has a stable and readily discernible value. The stable value is attained because the value of the novel digital currency, sometimes referred to herein as an international monetary unit, is commensurate with the value of a currency, for example a fiat currency, or other thing of readily discernible value, which is deposited in a trust account to back up the value of the novel digital currency. The international monetary unit is optionally designed to be exchanged within a blockchain network rather than a private network. The present invention further provides a system and method for transferring value that instead of transporting the item of value, for example, currency held in trust, exchanges ownership of the item of value. The item of value, e.g., currency, held in trust does not leave the trust account even though ownership of the novel digital currency backed by the item of value is transferred numerous times. The system of the present invention may be considered to be analogous to purchasing a house or other real estate; the purchased real property does not move, only the ownership of it does. The present invention accomplishes this through the use of a “digital equivalent” of a specific currency. This allows transferring the ownership of the physical currency or other thing of value, while the physical currency or other thing of value remains in one place in a trust account. The physical currency or other thing of value leaves the trust account only when and if a current holder of the corresponding novel digital currency redeems the digital currency by surrendering it in return for the thing of value.

The present invention in general provides a novel system and method to eliminate the need to transport, whether physically or by electronic or other means, a fiat currency, or anything of value that can be represented in a digital format, through multiple electronic networks and financial and/or non-financial institutions for the purpose of transferring the ownership or title of that fiat currency or item of value from one individual or business entity to another individual or business entity.

Specifically, in accordance with the present invention, there is provided a method of transferring value between specific participants in a network of a plurality of participants, the network being controlled by a central authority which maintains a central data processing system, which optionally may comprise a blockchain network. The method comprises that each participant opens an individual member account with the central authority, the central authority applying to each member account a unique electronic membership code, whereby a first participant has a first individual member account, a second participant has an individual second member account, and so on. A group of one or more participating financial institutions participates in the network and maintains respective common deposit accounts, into any of which a plurality of participants may deposit a sovereign currency. The first participant deposits a sum of sovereign currency as a first deposit into a first deposit account maintained in a given financial institution and the financial institution which maintains the first deposit account advises the central authority of the identity of the first participant and the value of the first deposit. The central authority thereupon creates a first international monetary unit (“IMU”), records in the data processing system, which optionally may comprise a blockchain network, a first data entry which comprises at least the identity of the first participant and the value of the first deposit expressed in terms of the sovereign currency deposited. The first IMU is deposited into the first member account, and the first data entry information is provided to the first participant. The first participant may instruct the central authority to transfer at least a portion of the first IMU from the first member account into the second member account and specifies the sovereign currency in which the transfer is to be made, the central authority thereupon creating a second IMU and recording in the data processing system a second data entry comprising at least the identity of the second participant and the value of the second IMU in terms of the sovereign currency specified by the first participant. The central authority deposits the second IMU into the second member account, and adjusts the value of the first IMU to reflect subtraction from the first IMU of the value of the second IMU. The central authority provides at least some of the second data entry information to both the first participant and the second participant.

Other method aspects of the present invention include one or more of the following features, in any suitable combination. The network may be an international network and the first participant instructs the central authority that the first IMU or portion thereof to be transferred into the second member account be denominated in a specified sovereign currency which is different from the sovereign currency of the first IMU; the group of one or more participating financial institutions may comprise one or both of (a) a single financial institution having financial operations in two of more different countries and (b) a plurality of financial institutions having among them financial operations in two or more different countries; the group of participating financial institutions may maintain individual ones of the respective deposit accounts in different geographical areas, and when the network is an international network at least some of the individual ones of the respective deposit accounts are maintained in different countries and receive deposits in the sovereign currency of the country in which they are located; more than two participants may simultaneously transfer value from one participant to another; a participant may redeem from a given deposit account the entire value of an IMU in the participant's member account, and the central authority thereupon extinguishes in its records the IMU whose entire value was redeemed; communications among the central authority, the financial institutions, and the participants may be made by electronic communications; the central authority, in determining the amount of specified sovereign currency which corresponds to the IMU or portion thereof being transferred from the first member account to the second member account may take into account transfer factors in existence at the time the first member orders the transfer, the transfer factors comprising at least the foreign exchange rate between the sovereign currency of the first IMU and the specified sovereign currency; the second participant may deposit a second sovereign currency which is different from the first sovereign currency into a second deposit account maintained in a financial institution which may be the same financial institution which maintains the first deposit account or a different financial institution; the financial institution which maintains the second deposit account may advise the central authority of the identity of the second member and the value of the second deposit and the central authority will create a second IMU which records the identity of the second participant and the value of the second deposit in terms of the second sovereign currency; at least some of the participating financial institutions may maintain respective deposit accounts and respective pluralities of the participants may deposit sovereign currencies into the same deposit account.

Another method aspect of the present invention provides a method of transferring value between participants in an international network controlled by a central authority, the method comprising the following steps. Each participant opens an individual member account with the central authority, the central authority applying to each member account a unique electronic membership code and supplying to each participant that participant's electronic membership code to enable each participant to access that participant's individual member account. Accordingly, a first participant has a first member account, a second participant has a second member account and each other participant has a respective individual member account. A group of one or more financial institutions participates in the network and maintains respective deposit accounts for at least some of the participants. The group of participating financial institutions may comprise one or both of (a) a single financial institution having financial operations in two or more different countries and (b) a plurality of financial institutions having among them financial operations in two or more different countries. The first participant may deposit a sum of a first sovereign currency into a first deposit account maintained in a given finance institution, and the financial institution which maintains the first deposit account may advise the central authority of the identity of the first participant and the value of the first deposit. The central authority thereupon creates a first international monetary unit (“IMU”) which records the identity of the first participant and the value of the first deposit expressed in terms of the sovereign currency deposited, and deposits the first IMU into the first member account. The first participant may instruct the central authority to transfer at least a portion of the first IMU from the first member account into the second member account and specify a second sovereign currency different from the first sovereign currency in which the transfer is to be made. The central authority thereupon creates a second IMU which records the identity of the second participant and the value of the second IMU in terms of the second sovereign currency, the central authority taking into account transfer factors in existence at the time the first member orders the transfer, the transfer factors comprising at least the foreign exchange rate between the first sovereign currency and the second sovereign currency. The central authority deposits the second IMU into the second member account, and adjusts the value of the first IMU to reflect subtraction from the first IMU of the value of the second IMU.

Yet another method aspect of the present invention further comprises participants other than the first participant and the second participant simultaneously or sequentially depositing sums of sovereign currency into the respective ones of the deposit accounts and instructing the central authority to transfer to other participants all or part of their respective IMUs.

In some embodiments of the invention, at least one of the deposits made in at least one of the deposit accounts is a valuable commodity whose value in a fiat currency is readily ascertainable, such as, for example, ingots of gold, silver, or other precious metals.

In accordance with yet another method aspect of the present invention, an IMU may be transferred in whole or in part to a non-member by converting a selected IMU to an IMU voucher by attaching a security code to the selected IMU and providing the nonmember with the security code to enable the non-member to transfer the voucher for value.

Yet another aspect of the present invention provides a digital currency, the value of a given quantity thereof corresponding to the value of a deposit of a sovereign currency or other item of value deposited in a trust account, the value of the given quantity of the digital currency being denominated in a selected sovereign currency.

The digital currency may have one or more of the following features in any suitable combination: the trust deposit may comprise a sum of a sovereign currency; the value of the given quantity of digital currency may be denominated in a selected sovereign currency; the denomination of the sovereign currency may be changed from one sovereign currency to another by an owner of the given quantity of the digital currency; the digital currency may be made by an entity depositing an item of readily discernible value into a trust account, an issuing authority issuing to the entity a quantity of a digital currency, the value of which quantity corresponds to the value of the item of discernible value held in the trust account, and maintaining the item of readily discernible value in the trust account for the life of the given quantity of digital currency; the item of readily discernible value may be a deposit of sovereign currency into the trust account; the value of the given quantity of digital currency may be denominated in the same sovereign currency as the deposit of sovereign currency in the trust account; and the issuing of the given quantity of digital currency comprises issuing electronic data to the entity which made the deposit, the electronic data including at least a unique identity code and the value of the given quantity of digital currency denominated in terms of a sovereign currency.

A system aspect of the present invention provides a system for transferring value. The system comprises a network of a plurality of participants, a central authority, each participant having a member account maintained by the central authority, and a group of one or more financial institutions. The group comprises one or both of (a) a single financial institution having financial operations in two of more different geographic areas, and (b) a plurality of financial institutions having among them financial operations in two or more different geographic areas. The financial institutions maintain respective deposit accounts for receiving deposits of local sovereign currency made by a plurality of participants into a common one of the deposit accounts. An electronic communications system connects the participants. A data processing system managed by the central authority is connected to the communications system, the data processing system being capable of receiving from the financial institutions information identifying the individual depositors of deposits of sovereign currency into a common one of the deposit accounts, and creating for each depositor a unique identity and access code and an international monetary unit (“IMU”). The data processing system optionally may be a blockchain network. The value of the IMU is based on the value of each depositor's individual deposit in the common deposit account and is expressed in terms of the amount of local sovereign currency deposited by the individual depositor. The data processing system is also capable of receiving instructions from individual transferor depositors to transfer all or part of such depositor's IMU to a transferee participant, recording in the data base all such transfers, adjusting the values of the IMUs of the participants who are parties to a transfer, and adjusting the value of IMUs which are redeemed in whole or in part, and advising participants of the adjustment of the value of their respective IMUs.

Another system aspect of the present invention is that when the two or more different geographical areas are two or more different countries, the data processing system calculates the value of a transferred IMU by denominating the transferred IMU in the sovereign currency of the transferee participant and taking into account the foreign exchange rate between the sovereign currency of the transferor participant and the sovereign country of the transferee participant.

Another system aspect of the present invention provides for identity cards each having embedded therein a microprocessor chip and at least one such card being in the possession or control of one or more participating members, the microprocessor chip serving to store information relative to the member account of the member in possession or control of the identity card. This aspect of the invention further provides for a plurality of point of sale terminals connected or connectable in electronic communication with the central authority, the point of sale terminals being accessible by utilization of the identity card and entry of a personal identification number which is unique to each of the plurality of identity cards.

The following terms, whether in singular or plural form, as used in this application, shall have the indicated meanings. “Fiat currency” means a currency which a government has declared to be legal tender but is not backed by a physical commodity such as gold or silver. Fiat money is not fixed in value in terms of an objective standard but by supply and demand for the currency. “Sovereign currency” is a term which is used to distinguish fiat currencies of different nations as in the phrase “a sovereign currency which is different from the sovereign currency in the deposit account.” “USD” means US Dollars. “GBP” or GB Pounds Sterling means Great Britain Pounds Sterling. “JPY” means Japanese Yen. “AU $” means Australian Dollars. “FX” means foreign exchange. “Blockchain” or “blockchain network” means a type of digital ledger technology comprising a growing list of records (“blocks”) securely linked together using cryptography in such a way that once transactions are recorded the data in a block cannot be retroactively altered without altering all subsequent blocks. The terms “data processing system” and “central data processing system” are used interchangeably to describe the same component.

### BRIEF DESCRIPTION OF THE DRAWINGS

FIGS. 1-4 are flow charts which illustrate the system and methods of embodiments of the present invention;

FIG. 5 presents legends showing that FIGS. 6B through 11B are continuations of, respectively, FIGS. 6A through 11A.

FIGS. 6A/6B through 11A/11B are flow charts which illustrate specific transactions carried out using the system and method of embodiments of the present invention;

FIG. 12 is a schematic illustration of the relationship among a plurality of banks, the central authority and participants including merchants, the banks each maintaining a common trust account in accordance with an embodiment of the present invention;

FIGS. 13-16 are flow charts which illustrate, respectively, withdrawal, deposit, payment and transfer processes using embodiments of the system and methods of the present invention;

FIGS. 17 and 18 are flow charts which illustrate in the context of a transaction the relationship among banks, the central authority and participants in which the data processing system is a blockchain network; and

FIG. 19 is a schematic diagram showing the design of the system network and its integration within a blockchain network.

### DETAILED DESCRIPTION OF EMBODIMENTS OF THE PRESENT INVENTION

The practice of the present invention maintains the fiat currency or other items of value in a financial institution or other suitable location, and through the use of a unique digital medium, referred to herein as the International Monetary Unit (“IMU”), transfers the ownership or “title” to the fiat currency or other item of value. Basically, a plurality of participants, who may be individual persons or any type of business entity, make deposits of currency (or something else of value as described below) into common deposit accounts, the deposits being held in trust. Many participants deposit into the same deposit account with, of course, the value of each participant's individual deposit being recorded. The participants also open individual member accounts with a central authority which creates individual IMUs for each participant. The value of the individual IMUs is commensurate with the value of the individual's deposit in one of the deposit accounts. A transferor participant may order the transfer of his or its IMU, or part thereof, to a transferee participant, specifying the sovereign currency in which the transferee participant's resulting IMU is to be denominated. In this way, a transferor participant in, for example, the United States, may make a deposit in US dollars into a local deposit account and transfer, via the transfer of an IMU, a sum in, for example, Japanese Yen, to a transferee participant in Japan who may redeem the IMU in Japan in Japanese Yen. The central authority does the bookkeeping to credit and debit the various member accounts. The deposit accounts provide a potentially world-wide pool of local currencies from which IMUs may be redeemed by the transferee participant. Of course, the transferee participant may elect to transfer to another participant part or all of the IMU instead of redeeming the IMU by taking its value in cash.

The system of the present invention used to carry out the method of the present invention may be comprised of, but is not necessarily limited to, the following components:
a. a digital currency or “token” (referred to herein as an international monetary unit or IMU) whose value, unlike that of prior art digital currencies, is tied to a fiat currency;
b. a central data processing system which optionally may be a blockchain network;
c. a communications network that links participants using the system;
d. one or more financial or other institutions to manage one or more deposit trust accounts; and
e. A central authority to open member accounts which hold the IMUs and to control the operations of the method.

The system may further comprise the following additional components:
f. A plastic card embedded with a microprocessor; and
g. Electronic point of sale terminals or other devices for reading the microprocessor equipped cards.

The present invention enables provision of the same value transfer service as prior art traditional methods at no cost to the user of the service and still enables the provider of the service to make a respectable profit in rendering the services. Underdeveloped countries will benefit greatly from the invention because the fees that will be saved by poor expatriates, such as migrant workers, who periodically send money home will go back into those home economies. The World Bank estimates that sub-Saharan Africa could see an additional $16 billion in its economy if banks and third-party wire transfer agents (e.g. Western Union) would lower their fees to 5%. The present invention permits zero fees in a profitable system.

Use of the system and the method of the present invention will save consumers and businesses millions of dollars (or any other currency which may be charged as a fee for services) in fees normally charged by banks and third-party institutions for providing the service of transporting currency from one location to another.

### The International Monetary Unit (“IMU”)

Digital currency is simply a compilation of data which can have any meaning the designer of the digital currency wishes to assign. The novel design of the International Monetary Unit (“IMU”) digital “token”, i.e., digital currency, of the present invention sets it apart from all other digital currencies in that the method of the present invention links each IMU to a specific sovereign currency or other item of value that is held in trust at a specific financial institution or other suitable location. The data comprising the characteristics of each IMU are then stored in a central location by electronic or other means and from there can be transferred electronically from one owner to the next without the need to transport the specific physical asset, for example, cash or a valuable commodity.

Each IMU is assigned a unique identification number at the time of its creation. An IMU is created when it is exchanged for a specific fiat currency or item of value and its unique serial number will be maintained throughout its lifecycle, which is from the time of its creation to the time of its redemption for the fiat currency or item of value being held in trust. Once the IMU is redeemed (exchanged) for the fiat currency or item of value that is held in trust, the specific IMU and its unique serial number associated with the fiat currency or item of value are removed from the database of active IMUs and stored in an archive for future reference.

### Utilization of a Blockchain Network in the System

With the current iteration of the Internet—commonly referred to as “Web 3”—the level of security of a blockchain network is believed to be equal to, if not better than, traditional banking and payment networks, and it is believed that the benefits of the blockchain network far outweigh any risks associated with it.

The functional components of the present invention are essentially the same with or without use of a blockchain network in the system. A central authority and disparate regulated financial institutions and the IMU token are employed in essentially the same manner with or without the blockchain network being incorporated into the system of the present invention.

The additional feature of the blockchain network embodiment of the present invention is that the IMU token is designed to be exchanged within a blockchain network, rather than over a private network. This adds the following benefits to the present invention.

The blockchain network is an immutable record of all transactions, which record cannot be altered or destroyed.

As in the embodiment of the present invention which does not incorporate a blockchain network, the token value is created in the exact amount of the fiat currency that is deposited into any of the central authority trust accounts—e.g., $1 USD=$1 IMU or £1 GBP=£1 IMU, etc. However, current blockchain network technology provides for the addition of “smart contracts” that can be programmed into the creation of each IMU token. For example, one might use the IMU token to buy a house. The appropriate amount of IMU would be transferred to the seller but may not be “redeemable” for fiat currency until the buyer signs-off on a final home inspection.

Another benefit of incorporating blockchain network technology into the present invention is that the IMU token can be automatically “burned” (blockchain network terminology for destroyed) when the token is redeemed for fiat currency. This creates what is known as a “stablecoin”—a coin whose value is tied to an asset, which in the case of the invention is fiat currency. This guarantees that there will never be more IMU in circulation than there is fiat currency of the exact value backing them. There are a number of “stablecoins” being issued on a number of blockchain networks; however, several have been sanctioned by the SEC for not maintaining adequate collateral to maintain the “peg” to fiat value. The IMU of the present invention would also be the only multi-currency stablecoin, unlike others which are pegged to only one currency—generally the USD.

The IMU would be exchangeable with other digital tokens on a particular exchange. For example, a $IMU could be used to purchase an equal value of Bitcoin, Ethereum or any other token on a given exchange. The reverse is also true; a trader may wish to exit a volatile or losing position in Bitcoin and convert it to the IMU without the necessity selling the Bitcoin into cash which may trigger a tax event. This is currently a very popular use of stablecoins—in fact, 75% of all blockchain network transactions involve stablecoins.

### Descriptions of the Non-Blockchain Network Embodiments Generally Apply to the Block-Chain Network Embodiments

In the embodiments of the present invention which utilize a blockchain network the “central data processing system” and its functions are replaced by the blockchain network. Therefore, all descriptions herein of embodiments of the present invention which do not include the blockchain network, unless otherwise specifically noted, apply to the blockchain network embodiments with the substitution of the blockchain network for the central data processing system. It should be noted that

Once created, the IMU or a portion thereof can be electronically transferred from one participant-owner to another an unlimited number of times, without the need to move the underlying fiat currency or item of value which is referenced by that specific IMU from the location in which it is stored. Only when the underlying fiat currency or item of value is redeemed by the current holder of the specified IMU is the fiat currency or other item of value delivered to the participant-owner. The method of “minting” or creating the IMU may be modified in that the “sending” member designates the currency for the IMU to be transferred.

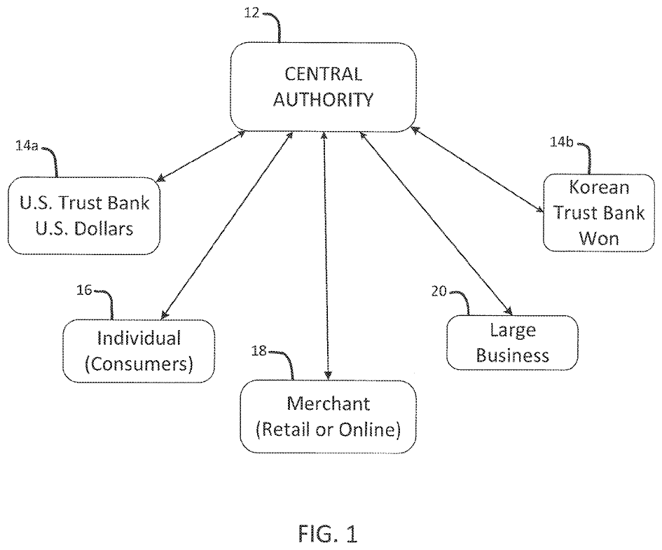

FIG. 1 schematically illustrates transactions among members (participants in the network) in an embodiment of the network of the present invention. FIG. 1 is a flow chart showing in an exemplary network 10 the relationship among the central authority 12 and, in the illustrated embodiment, a US trust bank 14a, a Korean trust bank 14b, an individual 16, a merchant 18 and a large business 20. The large business 20 is a business which frequently requires cross-currency payments, that is, which regularly makes and receives payments in sovereign currencies of different nations. US members (participants in the network) deposit their local currency, US dollars, in a trust account maintained by the US trust bank 14a. The US trust bank may, but need not be, a bank with international operations. A plurality of members (sometimes herein referred to as “participants”) make their deposits of US currency into a single, common trust account maintained by the US trust bank. Similarly, the Korean trust bank 14b maintains a single common trust account in which a plurality of Korean members deposit Korean Won. As indicated by the unnumbered double-headed arrows connecting the US trust bank 14a and the Korean trust bank 14b with the central authority 12, the individual deposits are reported to the central authority who then creates individual IMUs for the depositors. The IMUs are credited to member accounts maintained by the central authority 12. The central authority 12 utilizes its data processing system to credit individual depositors with IMUs denominated in their local currency and in an amount commensurate with the amount of their deposits. Communications between and among the participants as described herein and in the claims may be by any suitable electronic or other means, such as computers which generate and transmit emails and other communications.

The double-headed unnumbered arrows connecting, respectively, individual consumer 16, merchant 18 and large business 20 with the central authority 12 are lines of communication which enable any of those entities 16, 18 and 20 to instruct the central authority 12 to transfer IMUs or portions thereof to designated recipients or to redeem all or part of an IMU in their local currency. For example, an individual in the United States may order a transfer of an IMU or portion thereof to a member in Korea. The central authority 12 will in response create an IMU for the credit of the Korean recipient which IMU will be denominated in Korean Won, and the US transferor's IMU will be debited accordingly. The Korean recipient may transfer all or part of his newly created IMU to, for example, the merchant 18, in return for goods or services. The large business 20 may make or receive payments in different sovereign currencies utilizing the same procedure. It is important to note that currency deposited in the common trust accounts is not transferred to a recipient until a recipient decides to redeem the IMU for cash. For example, if the Korean recipient wishes to redeem the IMU credited to him, he may receive Korean Won from a local branch or ATM of the Korean trust bank 14b. Those funds will be paid out of the common deposit account maintained by the Korean trust bank.

Participants must open a member account at the central authority to become a member, that is, a participant in the network. There is normally no charge to open such account and participants may be a consumer 16, a merchant 18 or a corporation 20, as shown in FIG. 1. Each participant deposits a desired amount of funds into the common trust account maintained at a designated financial institution. The funds deposited in the trust account may be in any fiat currency, usually but not necessarily in the depositor's local fiat currency. In order to transfer or redeem IMUs, members must deposit currency in the trust account. Upon opening a member account, each member is assigned an electronic “safety deposit box” in the central authority database. In the embodiments of the present invention which utilize a blockchain network the safety deposit box is referred to as a “digital wallet”. The digital wallet may be provided by the central authority or by any number of third-party providers.

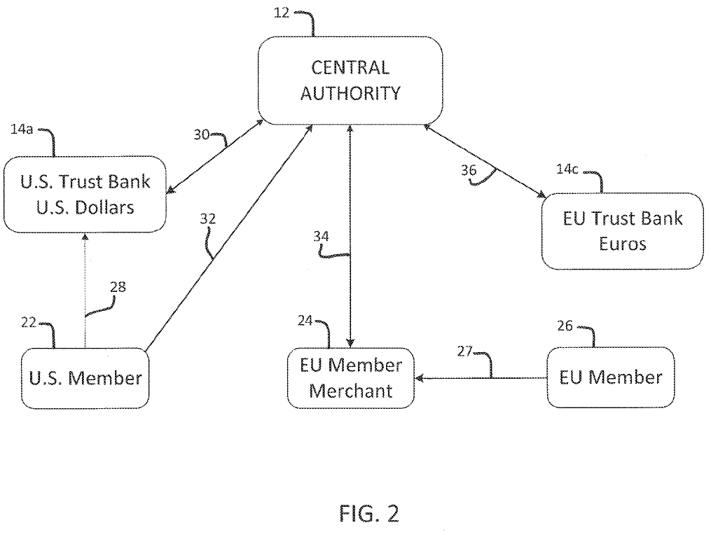

FIG. 2 illustrates utilization of an embodiment of the system and method of the present invention in a consumer-to-consumer transfer with a merchant member acting as an intermediary. (In FIGS. 1-4, identical entities are identically numbered.) In this example, the dealings are among US trust bank 14a, a European trust bank 14c, a US member 22, a European merchant member 24 and a European member 26. In this example, as indicated by the arrow 28, a US member deposits, for example, US $300 in the US trust bank. As indicated by arrow 30, the US trust bank reports the deposit to the central authority 12 and the central authority 12 deposits a US $300 IMU, which may be referred to as a “digital token”, in the member account of US member 22. US member 22 later directs the central authority 12 to convert the US $300 token to a 250 Euro digital token and to transfer the latter to the member account of EU member 26. The instruction is indicated by arrow 32. The 250 Euro IMU credited to EU member 26 is utilized by EU member 26 by presenting a card embedded with a microprocessor chip containing data identifying the member account to EU merchant member 24. This is indicated by arrow 27. As indicated by arrow 34, merchant 24 verifies with the central authority 12 the member account balance of 250 Euro and gives, in this example, EU member 26 the sum of 250 Euro in cash. Obviously, the merchant could instead have given EU member 26 merchandise costing 250 Euros. Merchant 24 may present the 250 Euro digital token to the central authority 12 to be credited to the member account of merchant 24. Alternatively, the 250 Euro digital token could have progressed through a series of transfers to others (not shown in FIG. 2) and eventually wind up in the member account of the last transferee of the digital token. Arrow 36 shows the usual communication line between central authority 12 and the Euro trust bank 14c.

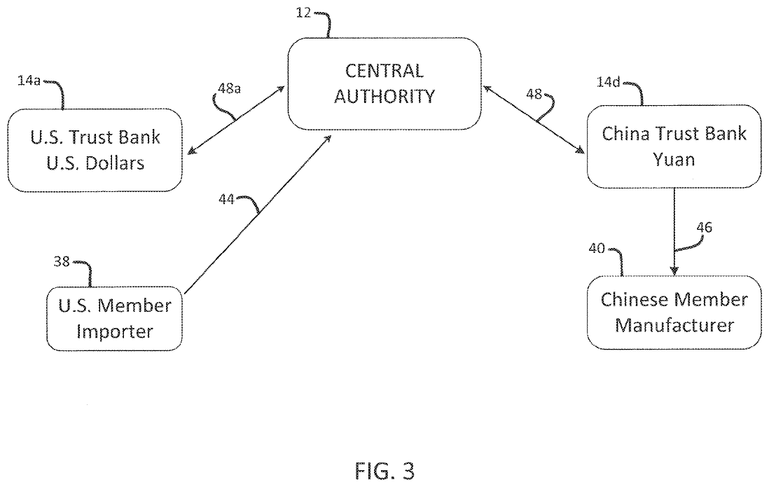

FIG. 3 schematically illustrates a business-to-business transfer. In this example, US member importer 38 deposits US $30,000 in the trust account maintained by the U.S, trust bank, as indicated by arrow 42. The central authority 12 deposits a US $30,000 IMU, sometimes referred to as a digital token, into the member account of US member 38. As indicated by arrow 44, US member importer 38 then directs the central authority 12 to convert the US $30,000 digital token of member 38 to a Yuan 200,287 digital token, and transfer the resulting IMU denominated in Yuan into the member account of the Chinese manufacturer 40. As indicated by arrow 46, Chinese manufacturer 40 withdraws 200,287 Yuan from the deposit account maintained by the China trust bank 14d. Arrow 48 merely indicates the usual line of communication between the China trust bank 14d and the central authority 12 for communication concerning deposits made into the trust account of China trust bank 14d, and arrow 48a indicates the same for communications between US trust bank 14a and central authority 12.

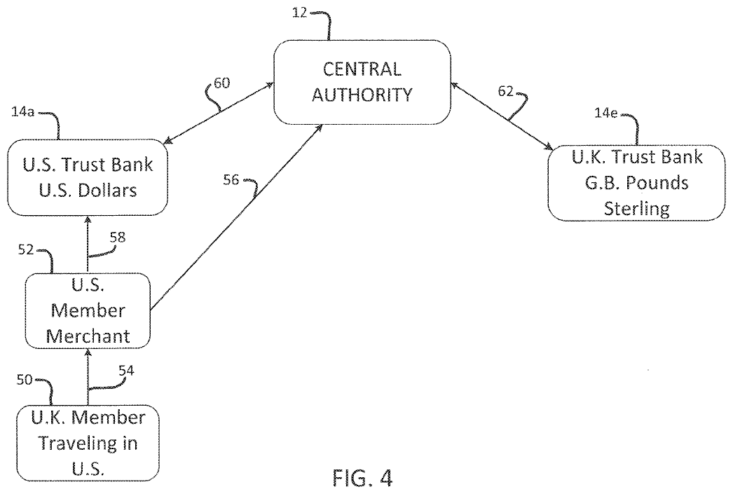

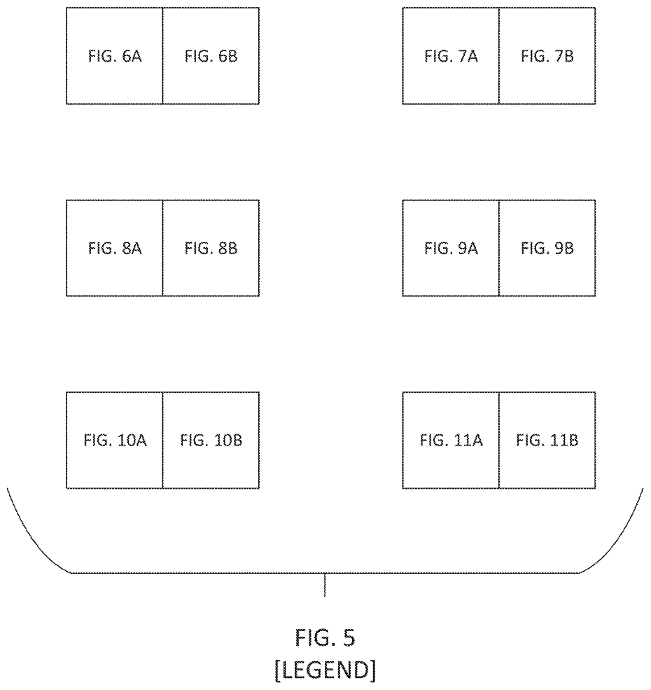

FIG. 4 illustrates a consumer purchase from a merchant carried out by using the network of the present invention. A UK member 50 traveling in the United States purchases from a U.S. member merchant 52 an item costing US $100 utilizing a central authority smart card or a central authority application on a mobile smart phone. The purchase is indicated by arrow 54. The central authority smart card is a smart card with a microprocessor chip containing the necessary information concerning the member account of UK member 50. The member account is the account which a member opens with the central authority 12. Similarly, the application for a mobile smart phone will include the same member account information. As indicated by arrow 56, US merchant 52 confirms the member account balance of UK member 50 and requests that the central authority 12 transfer a US $100 IMU into the member account of merchant 52. Central authority 12 converts a GB pounds sterling 76.17 IMU (digital token) to a US $100 token and transfers the US $100 token to the member account of merchant 52. As indicated by arrow 58, merchant 52 may now withdraw or transfer to another party US $100 from the trust account maintained by US trust bank 14a. Arrows 60 and 62 represent the communications between the central authority 12 and the trust banks 14a and 14e.

The trust accounts are maintained at a bank or other financial institution desirably but not necessarily having a branch or automated teller machine which is locally accessible to consumer or which is at least in the country in which consumer resides. Such access to a financial institution (or local merchant member as described below) enables access to the system by persons who may not have bank accounts and may need to receive cash in hand as part of a transaction. even in the absence of ready access to the bank, any merchant who is a member can easily provide the same cash-in-hand service. the system of the present invention will provide a large number of banking or other institution branches which are conveniently near the member. However, even if not conveniently near the member, the member could make deposits in a remote branch by mail or wire transfer or through participating member merchants.

After an IMU has been created, a typical transaction to transfer the IMU or a portion thereof to a recipient participant in a sovereign currency which is different from the sovereign currency in which the IMU was initially created may utilize the following type of information in the data processing system of the central authority. Consider a transaction in which an IMU purchased in US dollars is to be transferred in its entirety to a recipient and denominated in Japanese yen. Each IMU typically contains at least the following fields of data: Field 1: IMU unique Serial Number; Field 2: unique transaction Identification Number; Field 3: Currency Equivalent Identification; Field 4: Purchasing Currency Identification; Field 5: Exchange Rate; Field 6: Number of Units; Field 7: Currency Unit Value; Field 8: Owner Identification; and Field 9: Transferee Identification. At the beginning of the transfer, the IMU contains the following illustrative data: Field 1: AD1294BU5938X00932; Field 2: 1234567890123456789; Field 3: JPY; Field 4: USD; Field 5: 121.34; Field 6: 121338.00; Field 7: 1; Field 8: N8235HG9983V8815; and Field 9: 122453938MC9983XA. Fields 1 and 2; identification of the IMU to be transferred. Field 3, Japanese yen in this case; identification of the purchasing currency in Field 4 is US dollars in this case; Field 5 shows the exchange rate of the transferred (yen) to the purchasing (dollar) currencies on the date of transfer; Field 6 shows the number of units of the particular currency involved. For example, if the currency is US dollars and the number of units is 100, the value of the IMU is US $100; Field 7 shows the unit value of the purchased currency; and Fields 8 and 9 are unique identification numbers of, respectively, the owner, i.e., the purchaser or transferor, and the transferee. Remaining available Fields remain unused.

In the embodiments of the present invention which utilize the blockchain network, the unique transaction identification number is created by the blockchain network. In addition to the identification numbers, the IMU token can contain additional data describing terms and conditions of a specific transfer. For example, one could purchase a house with IMU tokens which are programmed to be redeemable only upon the purchaser signing off on a home inspection report.

The discussion in this paragraph applies to embodiments of the present invention which do not employ a blockchain network. After the transfer is completed, Fields 1 through 7 of the IMU are unchanged from the beginning of the transfer, but Field 8 now is, for example, changed to I22453938MC9983XA, to identify the new owner. Field 9 is now empty, and remaining available Fields remain unused. The serial number of the IMU remains in Field 1 until the IMU is redeemed for the yen in the trust account, at which time the serial number in Field 1 is retired. The currency, Japanese yen in FIG. 8, is never moved because of the transfer and remains as a credit in the trust account until withdrawn upon redemption of the IMU denominated in yen. If the transferor member does not wish to transfer the entire value of the original IMU, the number in Field 7 may be changed from 1 to a fraction less than 1 to reflect the fact that only a fraction of the unit value was transferred. For example, if only 5% of the unit value was transferred, the 1 is changed to 0.95. This allows for fractional exchange which is important for very small payments, such as payments less than $10. In such case, a new IMU serial number (Field 1) is issued to the new owner. However, when a blockchain network is employed, because of the efficiency of the blockchain network an IMU will never change value or characteristics from its original creation. The value and characteristics are maintained throughout the “life” of the IMU token (creation to destruction).

For example, a typical bank which is capable of and willing to act as the financial institution which maintains a trust account may have 1,700 branches and 5,600 automated teller machines (“ATMs”) in 71 countries. Members may make deposits into the trust account in person or online via automated clearing house (“ACH”) from the member's bank. It should be understood that there is only one trust account at each financial institution and that account essentially belongs to all the members jointly and their individual share of that trust account is evidenced by the IMUs that they hold in their international monetary exchange account. The network will grow as new merchants and, importantly, new banks join the system. The banks may be considered partners and the presence of at least one banking partner is of course necessary to have an institution capable of holding and recording transactions from the trust accounts. Further, if there is more than one banking partner the global footprint of the system increases dramatically, thereby bringing more banking branches and ATMs close to members and potential members. When a blockchain network is not utilized in the present invention, a plurality of banking partners also increases the likelihood that two or more members bank at the same banking institution and this will simplify transfers of funds between members' individual bank accounts and the trust account, as such transfers will only require a simple ledger entry. Perhaps the most important of these advantages is the convenience of a very large population residing within easy access of banking institutions which participate in the system 1. Further, members will be able to make deposits and withdrawals not only at banking institutions but at participating merchants, which is advantageous for persons who have no established relationships with banking or other financial institutions.

The system and method of the present invention is able to offer free consumer-to-consumer transfers because the central authority, which in effect acts as an international monetary exchange, derives its revenue from a number of other sources. First, the consumer-to-consumer product is subsidized by the participating merchants and corporations who pay a very small fee to use the service. Additionally, the central authority generates revenue from the currency foreign exchange spread. In essence, the central authority can use any currency exchange as long as it is able to trade at dealer rates. It is expected that at some point in time the central authority will become so large that it will be able to negotiate favorable rates with most currency exchanges.

Prior art digital currencies, e.g., Bitcoin, are unable to accomplish what the system and method of the present invention are able to accomplish for several reasons. All prior art digital currencies currently in circulation have no intrinsic value and their distribution is arbitrarily determined by the issuer of the digital currency. In some cases the issuers of the digital currency have allocated vast quantities of that digital currency to themselves. For example, one digital currency proprietor set an arbitrary limit of 100 billion of their “coin” and distributed 80 billion coin to themselves to fund operations. In addition, other digital currencies are not easily converted into fiat currency as they have no central authority to control the security of the network. They are therefore impractical for every-day commercial transactions because of the extreme volatility of such digital currencies.

The transfer of IMUs in the system and method of the present invention happens instantaneously. Once the transfer occurs, the recipient can redeem the IMU for its equivalent fiat currency at any one of the system's financial institution partner locations or at a participating merchant. The recipient may also choose to send the IMU along to another member or use the IMU at a participating merchant for goods and services.

There are a number of benefits that merchants will realize from being affiliated with the system of the present invention. For a small fixed monthly fee the merchants, such as merchant 18, can benefit from no swipe fees, no acquirer network fees, and no discount fees. Further, funds from the transaction are immediately deposited in the merchant's account in the system, where under the current systems some merchants wait days, even weeks (Swipe for example) before they can access their funds.

There are also many benefits that corporations, especially small to medium-sized businesses, may realize from using the system of the present invention to pay their overseas invoices through the international monetary exchange as opposed to using their own bank or other financial institutions. These include favorable foreign exchange conversion rates, a modest transaction fee, for example, 1%, that is capped at a reasonable level, for example, US $9.95 per transaction, and the ability to pay overseas vendors in the vendor's local currency. The latter feature can save tens of thousands of dollars in fees added by vendors to compensate for currency fluctuation.

The larger the network grows, the more valuable it becomes. The international monetary exchange trust account (trust account 10 in the illustrated embodiment) may grow to the point at which it will contain an inventory of currencies which is large enough to make it unnecessary to go to the open market to purchase foreign currencies.

The system of the present invention as envisioned herein is a financial “ecosystem”, e.g., system 1, where members will freely exchange IMUs knowing that, at all times, the value can easily be redeemed for any fiat currency. This is a feature that no other digital currency has.

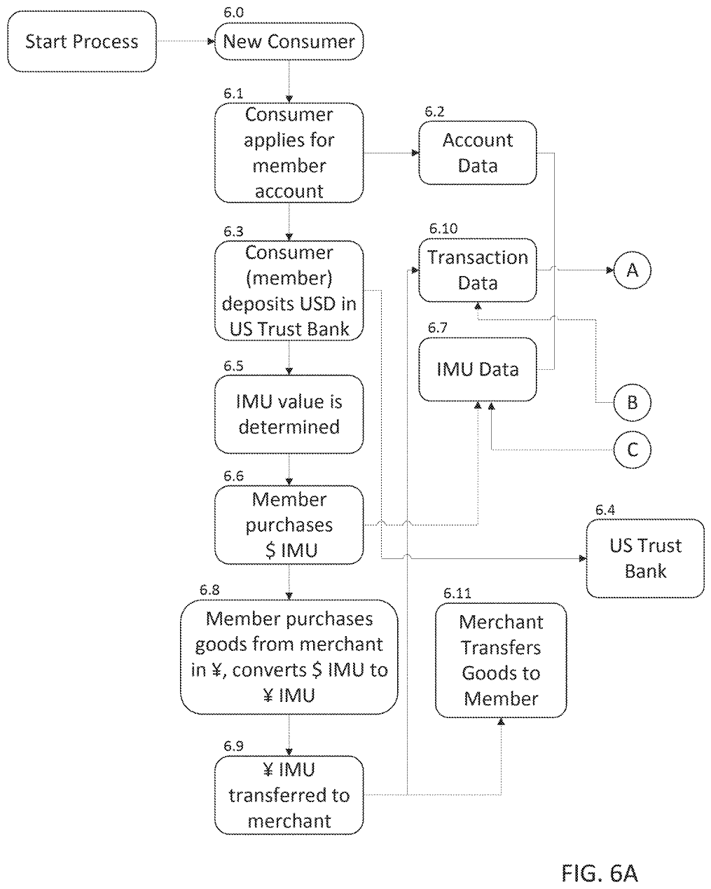

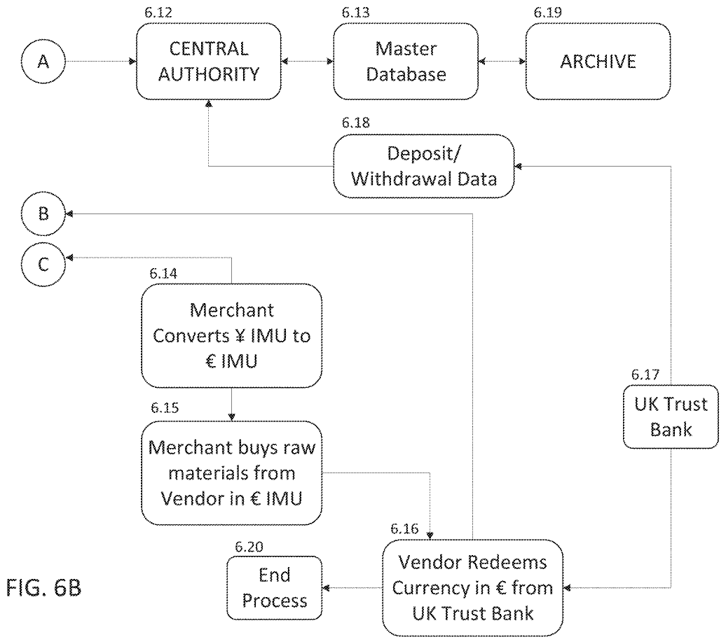

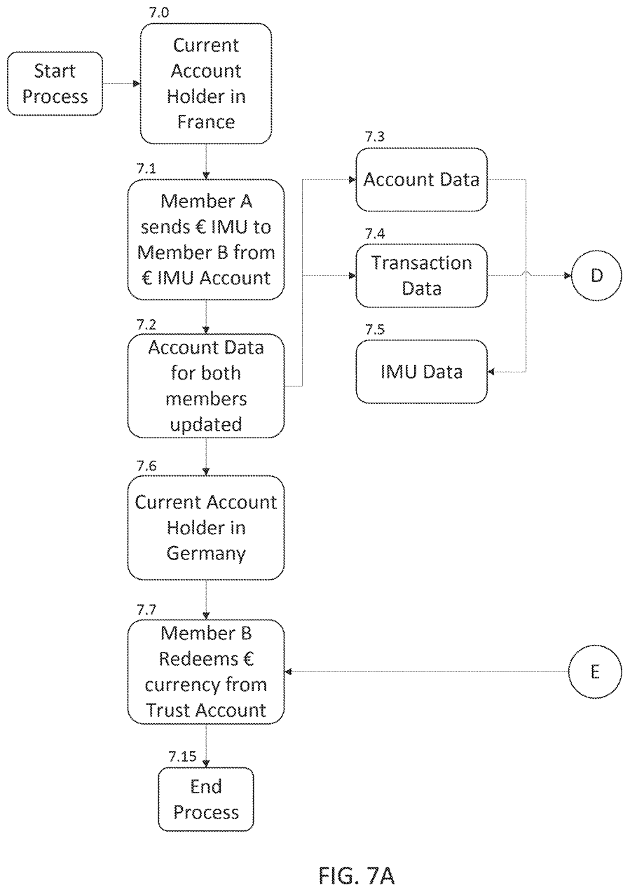

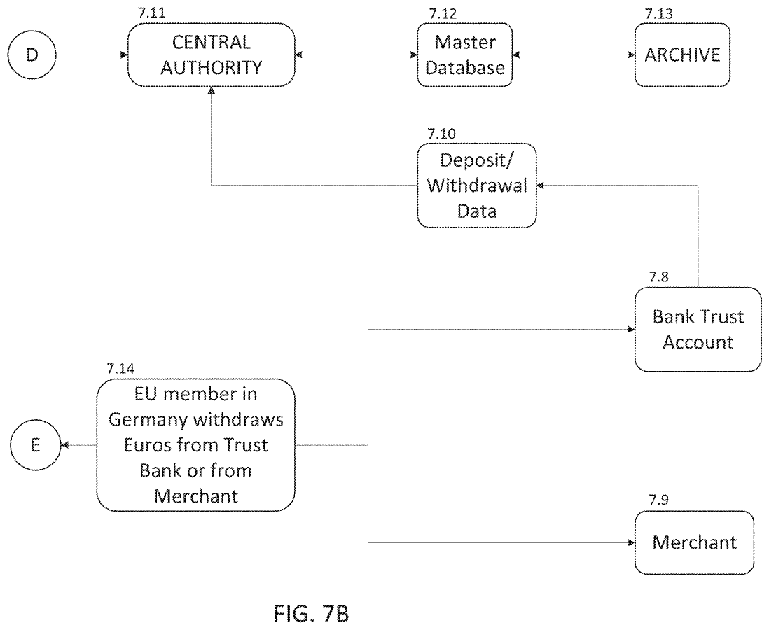

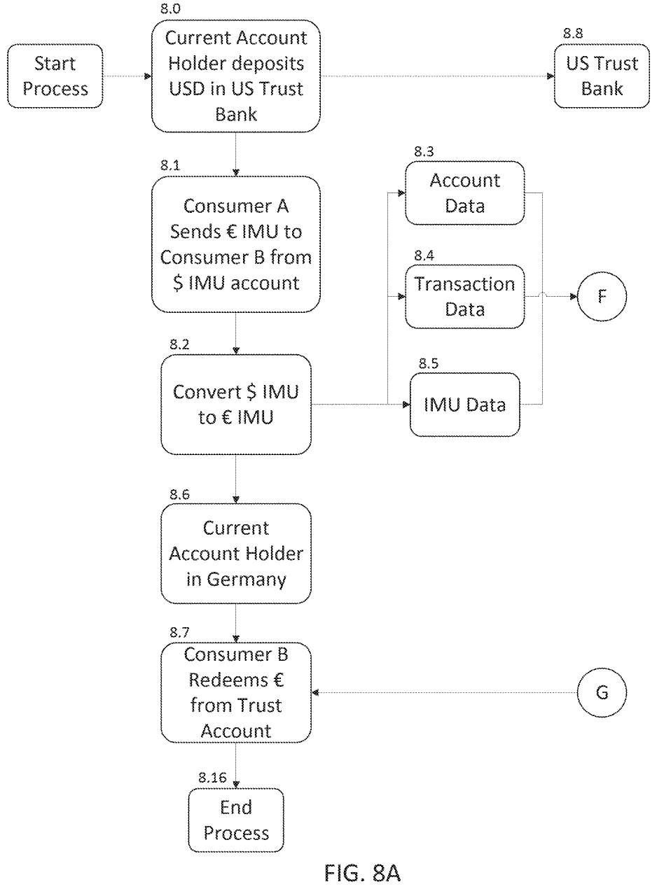

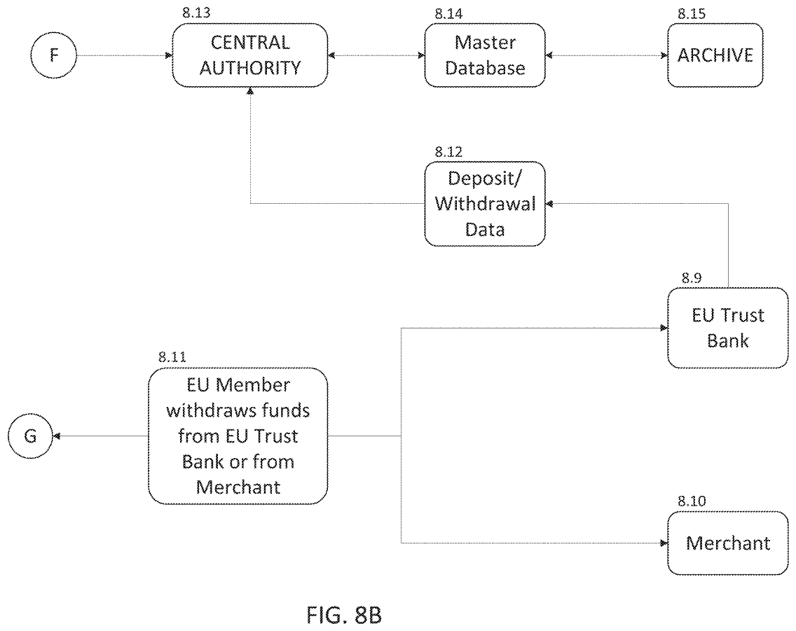

The following discussion provides a more detailed description of certain aspects of the present invention. The “financial ecosystem” of the present invention can best be described as a universal currency that will allow participants of the system to exchange value with one another without the need to pay expensive fees charged by banks and private third-party companies for the service of transferring and exchanging currency. FIGS. 6A through 12 illustrate the “financial ecosystem” in more detail. In FIGS. 6A/6B through 11A/11B a given line which crosses between an “A” figure and a “B” figure is identified by the same circled capital letter in both the “A” figure and the “B” figure.

FIGS. 6A through 12 are flow charts showing various steps in particular embodiments of the system and method of the present invention. The steps are numbered but these numbers do not necessarily or always indicate the sequence of the steps, but also serve to identify specific steps to facilitate discussion.

FIGS. 6A and 6B schematically illustrate an example of a more complex transaction involving a consumer-to-merchant transaction (FIG. 6A) and a merchant-to-vendor transaction (FIG. 6B), including three transactions in three different currencies, US dollars ($), Japanese yen (¥), and British pounds sterling (£) where, in accordance with practices of the present invention, currencies did not leave the trust account. The only fees incurred are the merchant's monthly membership. No other fees for any of the transactions are charged to merchant or consumer and the normal foreign exchange rate spread is applied. The central authority 12 serves as an administrator and coordinator of communications and activities among members (merchants, consumers, financial institutions, etc.). FIGS. 6A and 6B show a new consumer opening an account with the international monetary exchange central authority 12 by depositing funds in the trust account 10a (not shown in FIG. 9) in the financial institution 10. The resulting IMU units are credited to that new consumer in the international monetary exchange master database.

FIGS. 7A and 7B illustrate a member to member, in this case a consumer to consumer, transaction not involving a foreign currency exchange, that is, the transaction concerns only one national or regional (Euro) fiat currency although the participants in the transaction reside in different countries, France and Germany. In the illustrated embodiment, value is transferred through the IMUs with, obviously, no foreign exchange rate considerations inasmuch as the Euro is a common currency to both France and Germany.

FIGS. 8A and 8B illustrate a member to member, in this case a consumer to consumer transaction involving a foreign currency exchange, Euros and US Dollars. The transfer is between consumers in different currencies in a situation where a foreign exchange rate conversion is necessary. In the illustrated embodiment, one consumer is in the United States and the other in Germany.

FIGS. 9A and 9B illustrate what may be referred to as an international monetary exchange “ecosystem” of the present invention. FIGS. 9A and 9B show an overall view of how each member of the network can interact with any other member of the network, regardless of that member's classification (individual, small or large merchant, large business, financial institution, etc.) and irrespective of the location of the member or the currency involved in the transaction. The unnumbered arrows indicate the interactions between various members (participants) and their interactions with the central authority 12, both for online shopping (FIG. 9A) and on-premises shopping (FIG. 9B).

FIGS. 10A and 10B illustrate how a member can transfer funds to a nonmember through the utilization of a voucher mechanism. FIGS. 10A and 10B schematically illustrate a member-to-non-member voucher transaction, both with a foreign exchange conversion (FIG. 10A) and without a foreign exchange conversion (FIG. 10B). While some or many recipients in underdeveloped countries may have mobile phones, they usually do not have the sophisticated smart phones which facilitate receiving mobile fund transfers. The voucher system of the present invention allows anyone, regardless of whether or not they possess a mobile device or a computer, and whether they reside in a developed or underdeveloped country, to receive funds from a member of the network. As participation by merchants grows there will be more locations at which the vouchers can be redeemed in addition to the bank branch locations. As shown in FIG. 10A, after conversion of an IMU to the desired sovereign currency, Euros in the embodiment illustrated in FIG. 10A, the Euro denominated by an IMU or part thereof may be designated as a voucher and its associated security code sent to a non-member as illustrated in Steps 10.2 and 10.3 of FIG. 10A. The non-member then may visit a participating merchant and present the security code whereupon the voucher Euro IMU is transferred to the merchant account (Step 10.10 in FIG. 10B). As indicated in Step 10.11, the merchant after verifying the security code, gives cash to the non-member. Alternatively, the merchant may give goods or services to the nonmember to the value of the IMU voucher. In the embodiments of the present invention utilizing a blockchain network as the central data processing system, the voucher system is no longer required because all members would be provided with a “chip and PIN) personal identification number)” debit card which will allow the members to access the network from authorized merchants or kiosks.

FIGS. 11A and 11B illustrate member-to-member on-line transactions with a foreign exchange conversion in the context of a transaction with an online merchant. Not all merchants are brick and mortar and all online purchases are paid via electronic methods. Member merchants with online businesses will have the advantage of being able to accept electronic payment for their goods and services in any currency, with no transaction, swipe or network fees. More importantly, the ability of the IMU to be divided into fractions of a unit allows merchants to accept micropayments where otherwise those transactions would not be financially feasible. This is particularly important to merchants who sell content. By example; in order to read the Wall Street Journal online, you must purchase a subscription for the entire publication. That is considered the “All or Nothing” concept. The IMU would allow content merchants to sell single articles which may be of interest to a reader without the necessity to purchase a subscription. For instance, a single article may be purchased for $0.95—a transaction which could never be conducted electronically due to the fees. A particularly inventive use for micropayments would be to prevent SPAM. An email system would require the attachment of a micropayment in order to be passed by the server to the recipient. This payment—perhaps $0.01 or less would be insignificant to the sender, but to spammers it would be a substantial investment to attach even such a small fee to millions of emails.

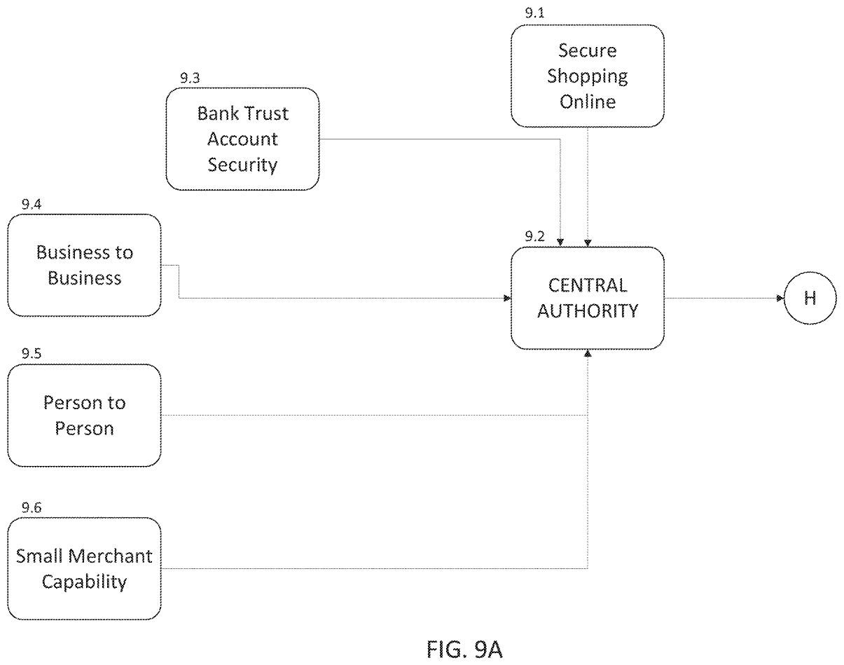

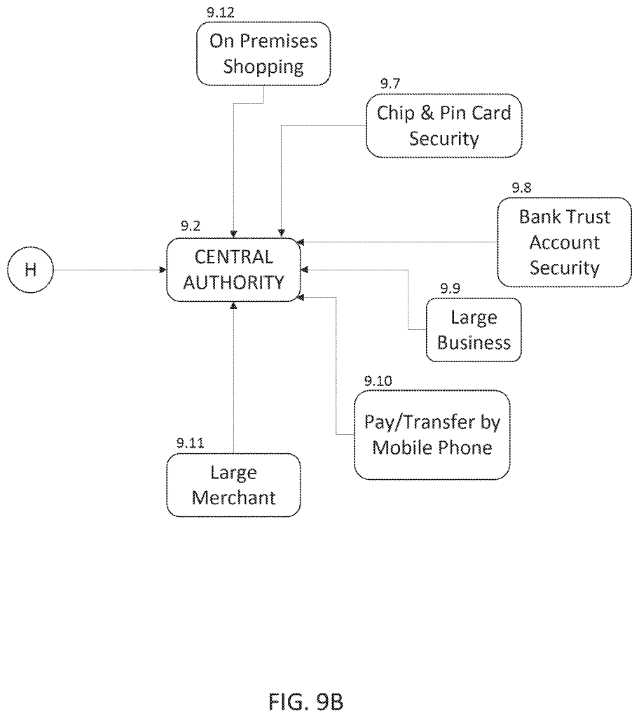

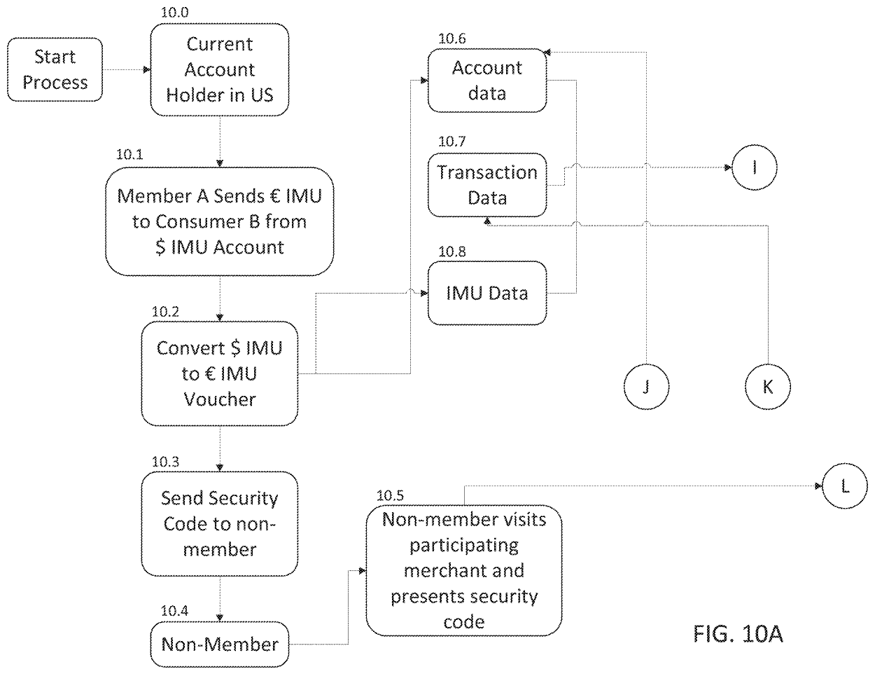

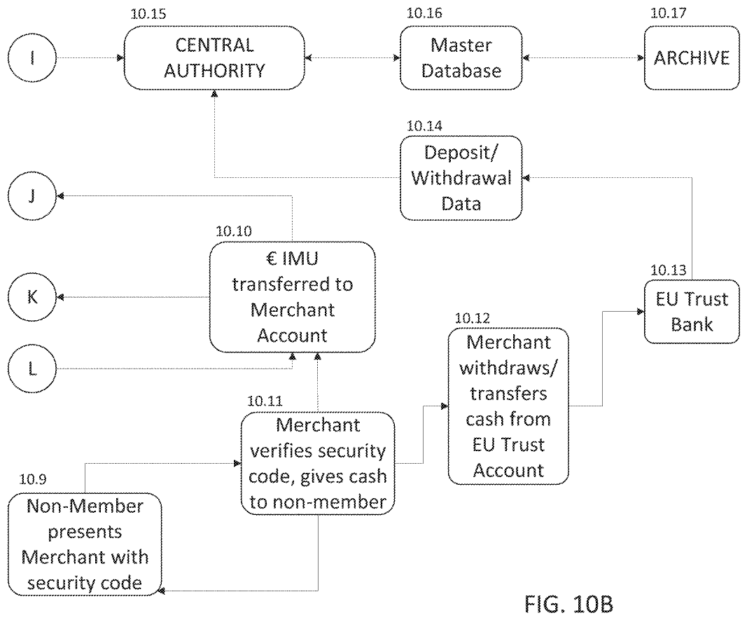

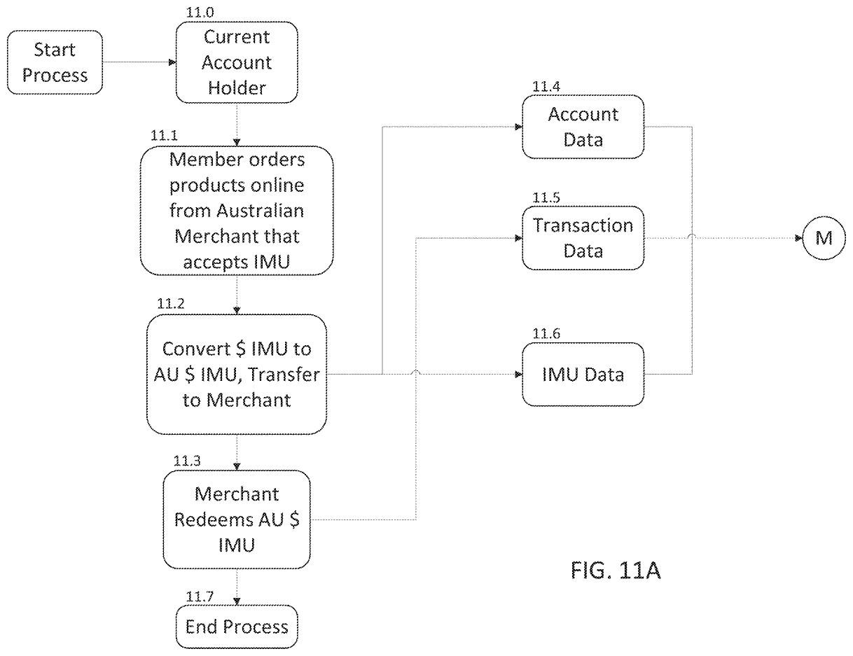

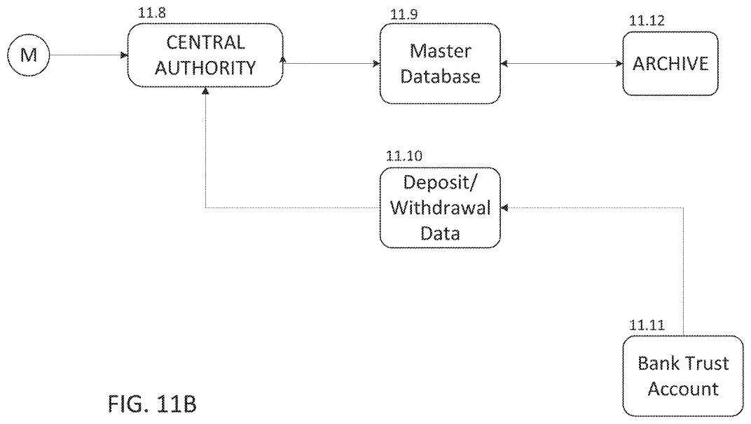

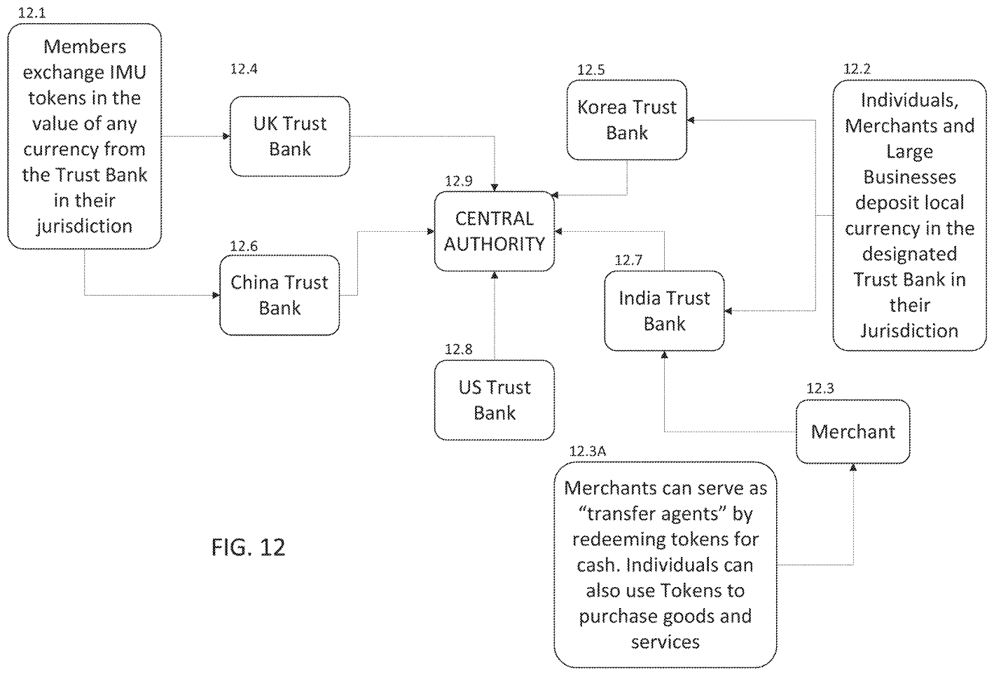

FIG. 12 is a schematic illustration of the relationship between various trust banks and the central authority 12. In the illustrated embodiment, US, Korean, UK, China and India trust banks are all members of the network in communication via the unnumbered arrows with the central authority 12. Individuals, merchants and large business around the world deal with their local trust banks to deposit funds into the common trust account maintained by each of the trust banks and to have IMUs generated in their respective member accounts maintained by the central authority. FIG. 12 graphically demonstrates how a vast number of currency transactions can occur between members without the physical currency ever leaving the trust account until and unless it is finally redeemed. Most of these transactions will occur without any fee to the members unless the currencies are converted from one country to another and then only the customary FX spread would apply.

Another novel feature of the IMU is the ability to change characteristics as it is transferred from one owner to another. An IMU can only be created when it is exchanged for a specific fiat currency or item of value at which time the characteristics of that fiat currency or item of value will be electronically, or by other means, stored as data in that specific IMU.

By way of example; an IMU is created (as described above) in exchange for US $100 which is deposited into a trust account at a specific financial institution or other entity participating in the network. The data contained in the IMU identifies the following information:
the serial number of the IMU;
the type of value represented by the IMU: (USD in this example);
the specific quantity of the value represented by the IMU: (USD100 in this example) can be fractional, that is, a selected portion of an IMU may be transferred;
the ID number of the current owner of the IMU: A number generated by computer;

the ID number of the specific financial institution where the value is stored: A number previously generated to identify a specific financial or other institution or entity; and
other additional data necessary for tracking and control of the IMU—such data could include information such as an Invoice Number or other identifying or control information.

### EXAMPLE 1

If the current owner of the IMU wishes to exchange (as in exchange one IMU for another) or transfer the IMU to another individual or entity, additional information would be added to the dataset of the specific serialized IMU.
(a) The ID number of the new owner of the IMU: a number generated by computer to identify an entity such as a merchant who is a participant in the network.
(b) If the current owner is transferring the IMU in its entirety and in its current form, no changes will be made to the dataset other than the addition of the information of the recipient. However, if any of the characteristics of the current IMU are changed, the dataset of the current IMU will be altered to reflect the changes and, if necessary, a new IMU will be created in the name of the recipient.

### EXAMPLE 2

Assume that the current owner of an IMU denominated in US Dollars wishes to transfer the IMU, or a portion of it, to a transferee participant in GB Pounds Sterling. In that case, the current value of the IMU (or a transferred portion thereof) will be converted from its value in US Dollars to its value in British pounds sterling at the exchange rate prevailing at the time of transaction, and a new IMU will be created.
(a) The new IMU will have the following information:
   the serial number of the new IMU;
   the ID number of the transmitting owner, which number may be generated by computer;
   the ID number of the recipient owner, which number may be generated by computer (this number does not necessarily represent an individual or entity as it may take the form of a voucher that can be redeemed at a specific financial institution or other location—such as a merchant who also participates in the IMU network);
   the type of value represented by the original IMU: USD;
   the specific quantity of the value represented by the original IMU: 100 (or any portion thereof);
   the type of value into which the current value will be created: GBP;
   the current exchange rate used to calculate the new value, for example, 0.6429 GB Pounds Sterling per USD;
   the resulting new value of the transferred IMU is £64.29;
   the ID number of the specific financial institution where the value is stored: a number previously generated to identify the specific financial or other institution or entity; and
   other additional data necessary for tracking and control of the IMU—could include such information as an Invoice Number or other identifying or control information.
(b) If the prior holder of the IMU (the transferor participant) wished to send only a fraction of the stored value, the existing IMU dataset would be changed to reflect the new reduced value of the retained portion of the IMU and a new IMU would be created for the recipient, that is, for the transferee participant.
(c) Transfer of the IMU, as depicted in the examples above, can occur a number of times (or until the entire value is depleted by participants redeeming their IMUs) without the underlying fiat currency or item of value ever being redeemed from the location in which it is being stored. Transfers of IMUs or part thereof between account holders is instantaneous and without cost to either party.
(d) It may be that as in part (a) of this Example 2 the holder of an IMU has need to convert the IMU from its current fiat currency value, to that of another fiat currency value not currently held in the trust account. For example, conversion from the Euro to the Rwandan Franc. In that case, the central authority would place an order in the currency markets to purchase Rwandan Francs with Euros, at the prevailing exchange rate and deposit the Rwandan Francs in the trust account of the financial institution from which it is to be drawn.

### EXAMPLE 3

A US Dollar (“USD”) USD/IMU is converted to a British pound sterling (“GBP”) GBP/IMU, which can then be converted to a Japanese yen (“JPY”) JPY/IMU, which can then be converted to a Swiss franc (“CHF”) CHF/IMU, and so on. If and when the holder of the IMU wishes to redeem (exchange) it for the value currently stored in that IMU, that specific value will be released from the trust account of the specific institution which is identified in the dataset (in the data processing system of the central authority) as the current location of storage.

### EXAMPLE 4

The current holder of a specified IMU desires to exchange the IMU for the fiat currency or value indicated in the dataset. In its present form, the IMU in this example has been transferred several times and the final value is ¥500.25 (Japanese Yen). The current holder would present his unique identification number to the financial institution or other entity on the network, such as a participating merchant, as identified in the dataset of the IMU. The institution or merchant would then release the ¥500.25, thereby redeeming the IMU. Presentation of the IMU to the financial institution or other entity can be accomplished in accordance with the present invention through the use of a plastic card having an embedded microprocessor chip, which chip contains data relevant to the identification number with which it is associated. This action, the redemption of the IMU, represents the end of the lifecycle for the IMU identified by the specified serial number, at which point this IMU is removed from the database of active IMUs and archived.

Although the IMU in Example 4 began its lifecycle as USD it ended its lifecycle as JPY. And while it may have been converted to any number of different currency values along the way, at no time did those currencies leave the trust account and none of the transfers of the IMU would have incurred any cost to either party, including the final redemption of the JPY fiat currency—with the exception of the costs concomitant with converting from one currency to another which would be a normal occurrence in every day commerce.

### Micropayments

A novel feature of the present invention is the ability of the IMU to transfer small or “micro” payments down to the lowest denominator of a specific fiat currency and transfer the micropayment without fee. By way of example, the USD IMU can be broken down into units of $0.01. This allows merchants, particularly online and ecommerce merchants, to sell low-cost goods without the need to pay credit and debit card fees which can destroy the potential profit margin or must be passed on to the consumer, adding to the cost of the goods. By way of example, Apple has a neutral profit position on iTunes because after the royalty fee paid to the artist and the fee charged by the payment companies the profit margin is only a few pennies. With the proposed invention, Apple would be able to accept the $0.99 payment for the purchase of one song without the need to pay any transaction fee. Foreign purchasers would also be able to pay in any currency with no transaction fees. Normal FX fees however would apply.

### The Central Authority

The central authority is a component of the system and method of the present invention. The central authority is the entity that is responsible for managing the operations and security of the process. The central authority will employ people, equipment and systems that will control the issuance and tracking of the IMUs and the accounts of the members of the network. The central authority will be responsible for the security of the network that will process the transactions between participants, the financial institutions and the currency markets when required.

The optional use of a blockchain network as the central data processing system of the central authority provides the following benefits to the present invention.

The blockchain network is an immutable record of all transactions that cannot be altered or destroyed. The value of the IMU token fiat currency is created in the exact amount of the fiat currency that is deposited into any of the central authority trust accounts—e.g., $1 USD=$1 international monetary unit or £1 GBP=£1 international monetary unit, etc. However, current blockchain network technology provides for the addition of “smart contracts” that can be programmed into the creation of each international monetary unit token. For example: one might use the international monetary unit to buy a house. The appropriate amount of international monetary unit would be transferred to the seller but may not be “redeemable” for fiat currency until the buyer signs-off on a final home inspection.

Another benefit of incorporating blockchain network technology is that the international monetary unit token can be automatically “burned” (blockchain network terminology for destroyed) when the token is redeemed for fiat currency. This creates what is known as a “stablecoin”—a coin whose value is tied to an asset, which in the case of the invention is fiat currency. This guarantees that there will never be more international monetary unit in circulation than there is fiat currency of the exact value backing them. There are a number of “stablecoins” being issued on a number of blockchain networks; however, several have been sanctioned by the Securities and Exchange Commission for not maintaining adequate collateral to maintain the “peg” to fiat value, thereby causing a “run” on the token.

The international monetary unit would also be the only multi-currency stablecoin, unlike others which are pegged to only one currency—generally the US Dollar. The international monetary unit would be exchangeable with other digital tokens on a particular exchange. For example, a US Dollar international monetary unit could be used to purchase an equal value of Bitcoin, Ethereum or any other token on a given exchange. The reverse is also true; a trader may wish to exit a volatile or losing position in Bitcoin and convert it to the international monetary unit without the necessity selling the Bitcoin into cash which may trigger a tax event. This is currently a very popular use of stablecoins—in fact, 75% of all blockchain network transactions involve stablecoins.

In order to participate in the network, a user, which can be an individual or business or other entity, must open a member account with the central authority. This member account is not to be confused with the trust account maintained by the financial institution. The member account is required for the purpose of issuing, storing, transferring and maintaining records of the IMU transactions involving the member. No fiat currency or item of value, other than the IMU, is stored in these member accounts. Applicants for membership will be required to complete standard AML/KYC (anti-money laundering/know your customer) information to the central authority before a member account will be accepted. Once accepted, the member will be assigned an account number which will identify the member for the purpose of the issuance and tracking of IMUs and control of the accounting necessary to maintain balances between the issued IMUs and their corresponding asset(s) being held in trust in the trust account.

Although the central authority controls the issuance and tracking of the IMUs, it does not control the fiat currency or the items of value that are associated with the specific IMU. That process is discussed further in The Financial Institution section below.

### The Financial Institutions

The role of the financial institutions in the method of the present invention is separate and distinct from that of the central authority and there is no financial connection between the two. The financial institutions are responsible for maintaining a common trust account which holds the physical fiat currency or items of value deposited into the common trust account by a plurality of participants. Funds held in trust by the financial institutions are separate and distinct from the operating capital of the central authority.

The financial institution is also responsible for disbursing the physical fiat currency upon presentation of the IMU by the current holder. Presentation of the demand to disburse the fiat currency can be made through the microprocessor embedded card at the financial institution's ATM machine or in-person at the financial institution's branch location.

The central authority may maintain one or more trust accounts with one or more financial institutions as deemed necessary for the operations of the network.

### The Communications Network

The Communications Network may comprise the following components. A central computer system maintained at a data center, terminals for accessing data maintained on microprocessor embedded cards, such as: 1. Point of sale terminals or other electronic devices for reading a microprocessor chip at member merchants; 2. Bank or third-party ATM machines, Data transmission lines that link each of these components.

The communications network is the facility that allows the components of the proposed invention's “ecosystem” to exchange information regarding the transactions that occur on the network. Each account holder may receive a microprocessor embedded plastic card that will contain the data referencing the cardholder's identity. Account holders may also access this information and initiate transactions and account maintenance from their personal computers or smart mobile phones. In the blockchain network embodiments of the present invention, there is no longer a “central computer system maintained at a data center”. This is because all transactions in the blockchain network embodiments of the present invention are conducted over a distributed network which may comprise thousands of computers around the world which together comprise a particular blockchain network. The other components are as described in the immediately preceding paragraph and serve the described purpose.

Merchants who are members, i.e., participants, can accept the IMU digital currency as payment for goods and services by being given access to another member's microprocessor card. This aspect is similar to a bank debit card system.

### The Microprocessor Debit Card

The method of the present invention may utilize a plastic card embedded with a microprocessor chip that will be programmed to store information relative to the member account associated with the card. The individual in possession of the card must know the personal identification number (PIN) code associated with that card in order to engage in transactions within the network. Similar to a bank “debit” card, the card of the present invention can be used to complete transactions with other members of the network, including the redemption of the fiat currency from the trust account through ATM terminals of the financial institution, or in-person at a branch location of the financial institution, or from Point of Sale terminals at participating merchants.

The process of the present invention may be considered to be a financial ecosystem that provides in effect a “universal currency” that will allow participants of the system to exchange value with one another without the need to pay expensive fees charged by banks and private third-party companies for the service of transferring and exchanging currency. It is contemplated that at some point in the future, members will be primarily exchanging the electronic tokens (IMUs) whereby most of the physical fiat currency remains in the trust accounts earning interest which could be distributed amongst the membership, pro rata, in the form of dividends.

The present invention allows people from different countries to exchange value with each other without the need to use expensive third-party services like banks and Western Union. The present invention greatly facilitates the remittance market: for example, migrant workers who send money back to their home country to support their friends and family. Such remittances are often the only form of support for many in developing countries. Many of those consumers have no banking relationship, thus forcing them to use alternative, and expensive, financial services. But such consumers, and other consumers would benefit from the ability, in addition to sending remittances, to conduct more traditional banking services; such as the ability to make deposits and withdrawals, pay bills and open savings accounts even by persons who do not have access to the internet. This opens up the world of banking to those who formerly were unable to access it. With traditional bank branches closing by the thousands each year, and mostly in low-income neighborhoods, consumers are forced to use “cloud-based” banking alternatives. (Since 2018, about 2,000 branches have closed in the U.S. and about 9,000 in Europe.) However, this presents a problem for the nearly two billion consumers and businesses who cannot, for one reason or another, obtain access to the internet, such access being required by all cloud-based banking networks. The present invention is capable of providing services, basic transactional banking services, deposit, withdraw, pay and send, save at the remotest locations, without the need for consumer-provided technology or the physical presence of a banking facility.

The problem of a lack of “physical presence” of a bank branch or lack of access to the internet is solved by the use of a global network of member merchants, each of which provides “access points” to the platform of the present system through a proprietary terminal which allows the member to access the functions of the network of the present invention. Each member receives a personal identification number (“PIN”) and a plastic card embedded with a chip that is programmed to work in conjunction with the proprietary terminal at the merchant's location upon entry of the PIN.

The combination of these components acts in consort to perform the following functions. The IMU Token—which represents the fiat currency held in the accounts of the Central Authority. The Central Processing System—which maintains control, administration and security of each member's accounts and controls the issuing, tracking and exchange of the IMU's throughout the network. The Point of Sale Terminal—which provides access to the Central Processing System through a connection to the internet or the local cellular network. The Chip-Embedded Plastic Card—when programmed with the member's proprietary information, gives the member access to the Central Processing System through the Point of Sale Terminal at the merchant location, to perform the method's functions.

When specifically programmed, the integral use of these technologies serves to achieve the performance of the method of the present invention. The new functionality of general banking transactions thus added to the network requires customized, proprietary programming in order to perform the additional functions which are not offered by off-the-shelf card processing terminals.

Another aspect of the present invention enables a member, by use of a communication device, which may be a hand-held proprietary device, to transmit information to a financial institution which is a member of the system of the present invention. The financial institution may be a bank or a credit union in which funds in the local fiat currency have been deposited as part of the above-described network of the system for transferring value. Any member, e.g., an individual, who has a point of sale terminal, may access any member financial institution through an internet connection or a local cellular network. The point of sale terminal (“P.O.S. terminal”) may be a hand-held device, or a slightly larger counter-top register, which is fitted with proprietary know communication software. Such communication software itself forms no part of the present invention but enables the member to use an identity card having a near field communication (“NFC”) chip to access the P.O.S. terminal. The identity card, which may be outwardly configured identically to a conventional debit card or the like, enables the member to communicate via the P.O.S. terminal with a member financial institution to conduct banking transactions, as follows. Basically, a member uses the P.O.S. terminal to instruct a participating financial institution to, for example, withdraw or remit to another funds from the member's share of the common deposit account maintained by the participating financial institution. The participating financial institution then checks with the central authority to ascertain that the instructing member has sufficient funds in the common deposit account to cover the instructed transaction and, if so, the participating financial institution honors the withdrawal or remittal instructions and the instructing member's account is debited accordingly by the central authority. If the instructing member wishes to make a deposit into the common deposit account, that is, to start or augment the instructing member's share, the instructing member simply deposits his or her local currency into the individual member account maintained by the central authority with instructions to deposit part or all of the value of the deposited currency into the specified common deposit account.

A participating financial institution may elect to allow the central authority to participate in the financial institution's debit card platform, such as MasterCard, Visa or any other suitable such platform. The instructing member's identity card may be used in the manner of a debit card by disbursing the funds in the instructing member's common deposit account once the central authority has indicated to the financial institution that the instructing member has a sufficient share of the funds in the common deposit account maintained by the financial institution. This arrangement enables the instructing member to make purchases large and small by financing the purchases from the instructing member's share of the common deposit account. Those millions of “unbanked” people, those without ready access to a bank branch or automatic teller machine and lacking internet access or even a “smart” mobile phone or other such device, by use of the present invention, can gain full access to the banking system. The invention enables profitable operation without need to charge exorbitant or any fees to the individual member. The central authority may derive revenue from small fees charged to merchants who maintain the P.O.S. terminals, the “float” on deposits made to the participating financial institutions, fees for advertisements printed on the back of paper receipts or SMS messaging ads on the electronic communications, profit on foreign exchange rates in the case of international transactions, etc. The economics of the present invention can provide great financial relief to the millions of the poor who currently pay high fees for remittance of funds.

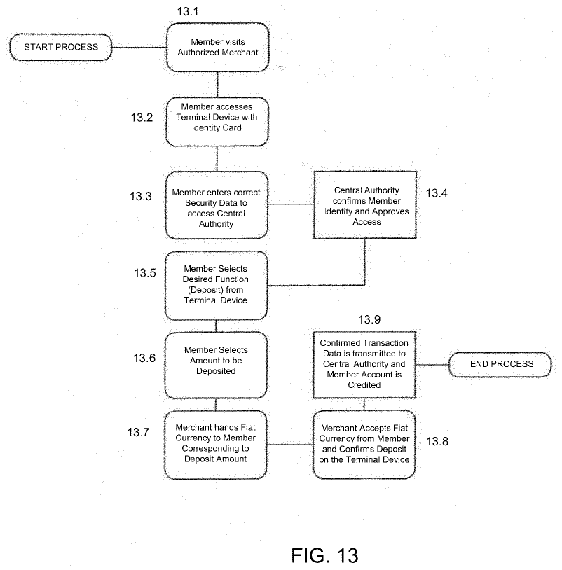

FIG. 13 is a flow chart of the process by which a member may make a deposit to augment his member account. In steps 13.1 through 13.4 the member visits an authorized merchant, that is, any merchant who is a participating member and accesses the P.O.S. terminal (“Terminal Device” in FIG. 13) with the member's identity card (“Identity Card” in FIG. 13) within which is embedded a microprocessor chip. The Terminal Device and Identity Card are both mentioned above. The P.O.S. terminal is accessed by the identity card and enters a security code which is unique to that member. The central authority confirms the member's identity and approves access. In steps 13.5 and 13.6 the member selects from the P.O.S. terminal the desired function, in this case to make a deposit and selects the amount to be deposited. In step 13.7 the member gives the appropriate amount of fiat currency to the merchant. In steps 13.8 and 13.9 the merchant accepts the currency and transmits to the central authority via the P.O.S. terminal the deposit transaction amount and the central authority credits the member's account with the deposited amount.

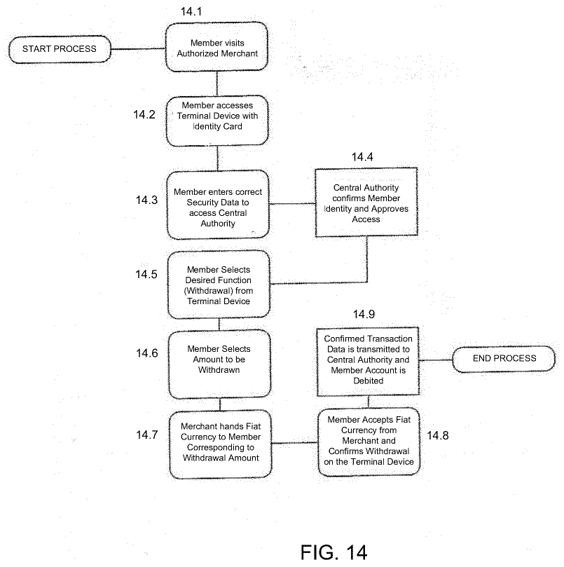

FIG. 14 is a flow chart of the process by which a member may effectuate a withdrawal from his or her member account. In steps 14.1 through 14.4, the member visits any Authorized Merchant, i.e., any merchant who is a participating member, and accesses the P.O.S. terminal (“Terminal Device” in FIG. 14) with the member's identity card and enters a security code which is unique to that member. The central authority confirms the member's identity and permits access to the system. In steps 14.5 and 14.6, the member selects from the P.O.S. terminal the desired function, a withdrawal in this case, and the amount to be withdrawn. In steps 14.7 and 14.8 the merchant gives the member fiat currency in an amount corresponding to the withdrawn amount and the member accepts the currency and confirms on the P.O.S. terminal the amount of the withdrawal. In step 14.9 the confirmed transaction data is transmitted to the central authority and the central authority debits the member's account the amount of the withdrawal.

FIG. 15 is a flow chart of the process by which a participating member utilizes the system of the invention to pay a participating member vendor. Steps 15.1 through 15.4 are the same as in FIGS. 13 and 14 and serve to permit access to the system by the participating member. In steps 15.5 through 15.7 the member selects on the P.O.S. terminal the desired function—a payment—the participating vendor who is to be paid, the amount to be paid and reviews and approves the payment. In step 15.8 the transaction data is transmitted via the P.O.S. terminal to the central authority where the paying member's account is debited and the vendor member's account is credited with the payment amount.

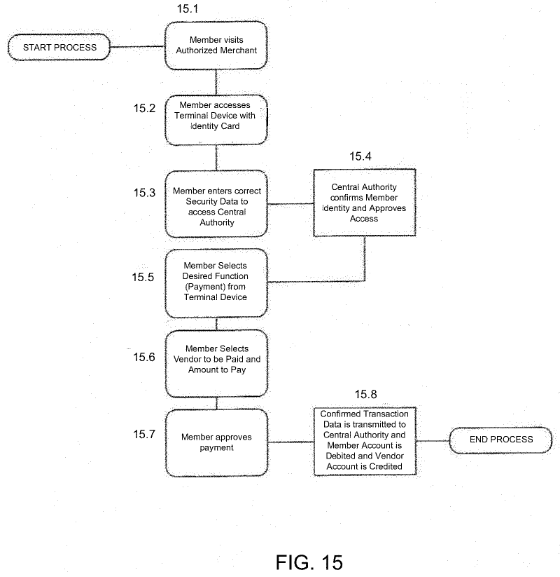

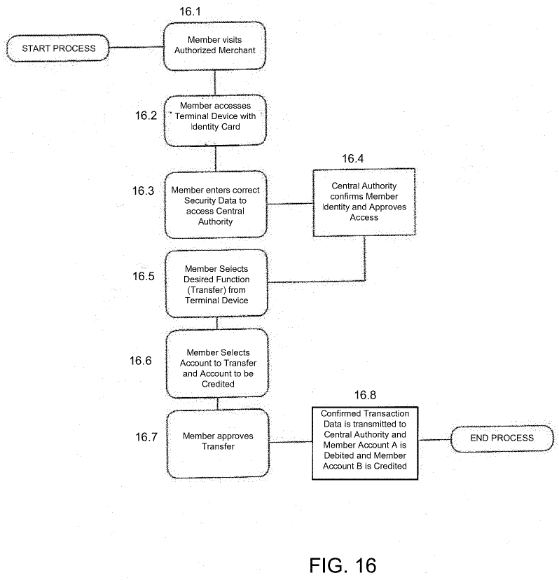

FIG. 16 is a flow chart of the process by which a participating member may transfer funds between two separate member accounts, which for the purpose of description, are here denominated Member Account A and Member Account B. Steps 16.1 through 16.4 are the same as for FIGS. 13, 14 and 15 and serve to permit the participating member to use his or her identity card in the P.O.S. terminal to access the system. In steps 16.5 through 16.7 the member uses the P.O.S. terminal to select the transfer function, select the account, e.g., Member Account A, from which funds are to be transferred and the account, e.g., Member Account B, to which the funds are to be transferred, and the amount to be transferred. In step 16.8 the transaction data is transferred via the P.O.S. terminal to the central authority, which debits Member Account A and credits Member Account B with the transferred sum.

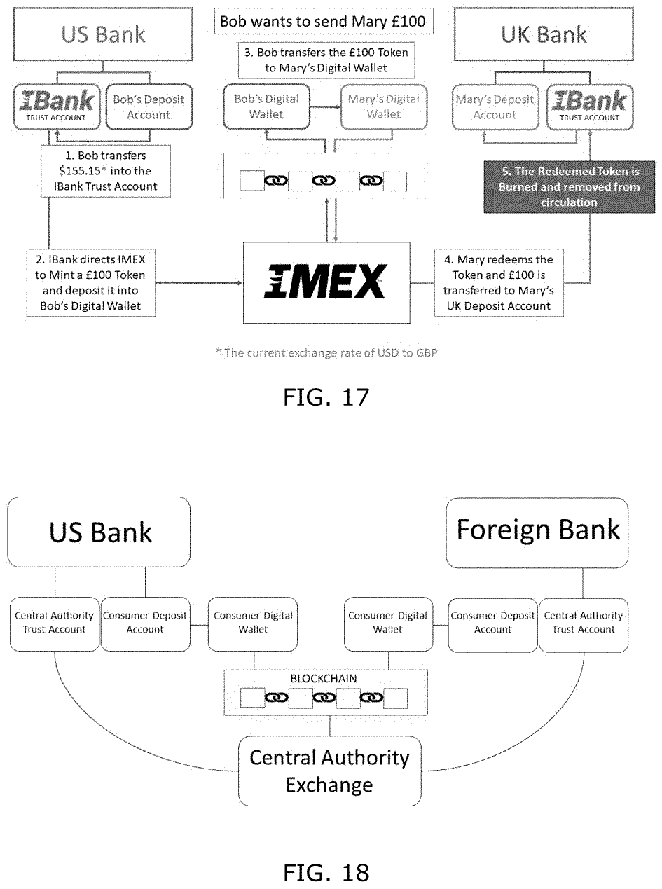

FIG. 17 is a flow chart which illustrates utilization of a blockchain network B in the transfer of British Pounds Sterling from the US to the United Kingdom utilizing the system of the present invention. Specifically, as shown in FIG. 17, if Bob, who is in the US, wants Mary, who is in the UK, to receive £100, he would transfer the appropriate amount of USD, in the example $115.55, into the central authority trust account. The central authority will cause an IMU token in the amount of £100 to be “minted” and place in Bob's digital wallet. Bob then transfers the £IMU to Mary's digital wallet; Mary can then redeem the £IMU back into GBP in the amount of £100 at which time the token is taken out of circulation by being “burned”. This process is referred to above as “. . . the central authority thereupon extinguishes in its records the IMU whose entire value was redeemed . . . ” The process is executed on the blockchain network in the blockchain network embodiments of the present invention.

FIG. 18 is a simplified and generalized version of the flow chart of FIG. 17 showing the use of the system of the present invention including a blockchain network in a situation where a US consumer purchases goods or services from a merchant either in the consumer's home jurisdiction or in an overseas jurisdiction, or in an online purchase where the goods and services may be priced in a currency different from the consumer's home currency. In all cases the process is the same with the transactions being routed over the blockchain network B.

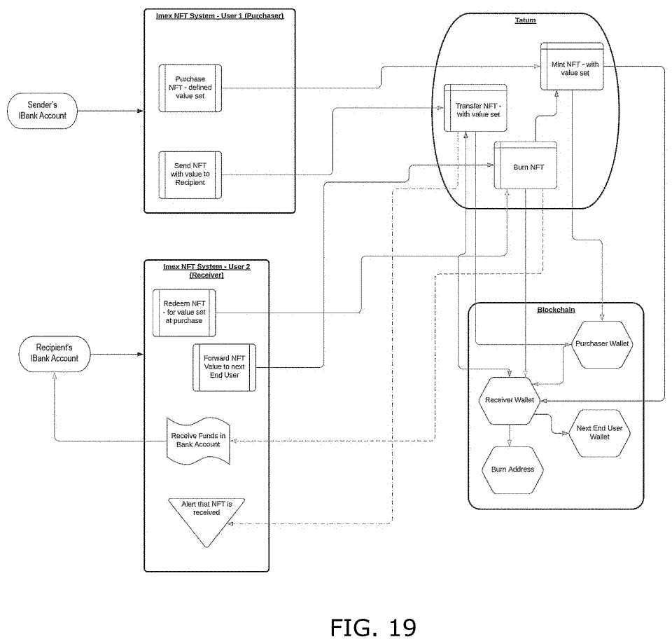

FIG. 19 illustrates the design of a network in accordance with an embodiment of the present invention and its integration within the blockchain network. The notation “NFT” stands for non-fungible token. An NFT is a representation of ownership of something, such as ownership of artwork or real estate. It is unique in that whereas typical cryptocurrencies can be exchanged for other things of value but the IMU NFT is essentially a “receipt” for fiat currency that is on deposit in some financial institution. It is specific to that particular deposit in that particular account and cannot be exchanged or traded but only redeemed for the deposited fiat currency.

While the invention has been described in detail with reference to specific embodiments, it will be appreciated that numerous variations may be made to the described embodiments, which variations nonetheless lie within the scope of the present invention.

What is claimed is:

1. A method of transferring value between specific participants in a network of a plurality of participants, the network being controlled by a central authority which maintains a central data processing system, the method comprising:
each participant opening an individual member account with the central authority, the central authority applying to each member account a unique electronic membership code, whereby a first participant has a first individual member account, a second participant has a second individual member account, and so on;
a group of one or more participating financial institutions participating in the network and maintaining respective common deposit accounts of the central authority, into any of which deposit accounts a plurality of different participants may deposit a sovereign currency to create a common deposit account containing sovereign currency which is under the control of the central authority;
the first participant depositing a sum of sovereign currency as a first deposit into a first deposit account of the common deposit accounts maintained by the central authority in one or more financial institutions;
the financial institution which maintains the first deposit account advising the central authority of the identity of the first participant and the value of the first deposit, the central authority thereupon creating a first international monetary unit (“IMU”), recording in the data processing system a first data entry comprising at least the identity of the first participant and the value of the first deposit expressed in terms of the sovereign currency deposited, and depositing the first IMU into the first individual member account maintained by the central authority, and providing the first data entry information to the first participant;
the first participant instructing the central authority to transfer at least a portion of the first IMU from the first member account into the second member account and specifying the sovereign currency in which the transfer is to be made, the central authority thereupon creating a second IMU and recording in the data processing system a second data entry comprising at least the identity of the second participant and the value of the second IMU in terms of the sovereign currency specified by the first participant, the central authority depositing the second IMU into the second member account, and adjusting the value of the first IMU to reflect subtraction from the first IMU of the value of the second IMU, and the central authority providing at least some of the second data entry information to both the first participant and the second participant.

2. The method of claim 1 wherein the central data processing system comprises a blockchain network.

3. The method of claim 1 wherein the network is an international network and the first participant instructs the central authority that the first IMU or portion thereof to be transferred into the second member account be denominated in a specified sovereign currency which is different from the sovereign currency of the first IMU.

4. The method of claim 3 wherein the central data processing system comprises a blockchain network.

5. The method of claim 1, claim 2 or claim 3 wherein a participant redeems from a given deposit account the entire value of an IMU in the participant's member account, and the central authority thereupon extinguishing in its records the IMU whose entire value was redeemed.

6. The method of claim 1, claim 2 or claim 3 wherein communications among the central authority, the financial institutions, and the participants are direct electronic communications and there is no communication with any other entity.

7. The method of claim 1, claim 2 or claim 3 wherein at least one of the deposits made in at least one of the deposit accounts is a valuable commodity whose value in a fiat currency is readily ascertainable.

8. The method of claim 1, claim 2 or claim 3 further comprising transferring an IMU to a non-member by converting a selected IMU to an IMU voucher by attaching a security code to the selected IMU and providing the non-member with the security code to enable the non-member to transfer the voucher for value.

9. A system for transferring value, the system comprising:
a network of a plurality of participants, a central authority, each participant having a member account maintained by the central authority, and a group of one or more financial institutions, the group comprising one or both of (a) a single financial institution having financial operations in two or more different geographic areas, and (b) a plurality of financial institutions having among them financial operations in two or more different geographic areas;
the central authority also maintaining respective deposit accounts in the financial institutions for receiving deposits of local sovereign currency made by a plurality of participants into a common one of the deposit accounts;
an electronic communications system connecting the participants;
a data processing system managed by the central authority and connected to the communications system, the data processing system being capable of: (a) receiving from the financial institutions information identifying the individual depositors of deposits of sovereign currency into a common one of the deposit accounts, and creating for each depositor a unique identity and access code and an international monetary unit (“IMU”), the value of the IMU being based on the value of each depositor's individual deposit in the common deposit account and being expressed in terms of the amount of local sovereign currency deposited by the individual depositor; (b) receiving instructions from individual transferor depositors to transfer all or part of such depositor's IMU to a transferee participant; (c) recording in the data base all such transfers and adjusting the values of the IMUs of the participants who are parties to a transfer, and adjusting the value of IMUs which are redeemed in whole or in part, and (d) advising participants of the adjustment of the value of their respective IMUs.

10. The system of claim 9 wherein the data processing system comprises a blockchain network.

11. The system of claim 9 or claim 10 wherein the two or more different geographical areas are two or more different countries, the data processing system calculating the value of a transferred IMU by denominating the transferred IMU in the sovereign currency of the transferee participant and taking into account the foreign exchange rate between the sovereign currency of the transferor participant and the sovereign currency of the transferee participant.

12. A digital currency, the value of a given quantity of the digital currency corresponding to the value of a deposit of a sovereign currency or other item of value deposited in a trust account, the value of the given quantity of digital currency being denominated in a selected sovereign currency.

13. The digital currency of claim 12 wherein the trust deposit comprises a sum of a sovereign currency and the value of the given quantity of the digital currency is equal to the sum of the sovereign currency of the trust deposit.

14. A digital currency made by an entity which deposits an item of readily discernible value into a trust account, an issuing authority issuing to the entity a quantity of a digital currency the value of which quantity corresponds to the value of the item of discernible value held in the trust account, and maintaining the item of readily discernible value in the trust account for the life of the given quantity of the digital currency.

15. The system of claim 9 or claim 10 further comprising identity cards each having embedded therein a microprocessor chip and at least one such card being in the possession or control of one or more participating members, the microprocessor chip serving to store information relative to the member account of the member in possession or control of the identity card, and
a plurality of point of sale terminals connected or connectable in electronic communication with the central authority, the point of sale terminals being accessible by utilization of the identity card and entry of a personal identification number which is unique to each of the plurality of identity cards.
